(19) United States
(12) Patent Application Publication
(10) Pub. No.: US 2026/0278375 A1
(43) Pub. Date: Sep. 17, 2026

(54) MODEL TRAINING METHOD AND RELATED APPARATUS

(71) Applicant: TENCENT TECHNOLOGY (SHENZHEN) COMPANY LIMITED, Shenzhen (CN)

(72) Inventors: Jiawei ZHAN, Shenzhen (CN); Jun LIU, Shenzhen (CN); Chengjie WANG, Shenzhen (CN)

(21) Appl. No.: 19/674,867

(22) Filed: May 12, 2026

Related U.S. Application Data
(63) Continuation of application No. PCT/CN2025/090801, filed on Apr. 24, 2025.

(30) Foreign Application Priority Data
Jul. 12, 2024 (CN) 202410934764.1

(51) Int. Cl. G06N 3/08

(52) U.S. Cl. CPC G06N 3/08

(57) ABSTRACT

A model training method is provided. A plurality of incremental branches is added to form, together with an original main branch in a first model, a plurality of processing branches. When sample data corresponding to a new data processing target is processed, processing operations of a same type can be performed in parallel by using the plurality of processing branches, and a processing result determined by a model can be outputted by combining processing results of the plurality of processing branches. The model parameters in the plurality of incremental branches are adjusted based on a difference between the pending processing result and an annotation of the sample data, to obtain a third model.

### CROSS-REFERENCES TO RELATED APPLICATIONS

This application is a continuation of PCT Application No. PCT/CN2025/090801, filed on April 24, 2025, which claims priority to Chinese Patent Application No. 2024109347641, filed with the China National Intellectual Property Administration on July 12, 2024 and entitled "MODEL TRAINING METHOD AND RELATED APPARATUS", the entire contents of all of which are incorporated herein by reference.

### FIELD OF THE TECHNOLOGY

This application relates to the field of data processing technologies, and in particular, to a model training method and a related apparatus.

### BACKGROUND OF THE DISCLOSURE

A model is one of popular tools used in the data processing field. Various complex data processing targets can be efficiently achieved by using different models. For example, tasks such as object detection, image processing, and probability prediction can be performed. To enable the model to have a data processing capability for achieving a specified data processing target, the training samples may be constructed for the specified data processing target, and the model is trained by using the training samples, so that the model learns how to achieve the data processing target.

However, in different data processing scenarios, data processing targets that the model needs to achieve may also be different. For example, in an object recognition scenario, the model needs to have different object recognition capabilities to recognize a person object and a non-person object, and in this case, parameter adjustment needs to be performed on the model. In this case, some parameters may be added to original model parameters, and only the newly-added parameters are adjusted in an adjustment process, so that adjusted newly-added parameters can bring a specific targeted data processing capability to the model, to achieve a new data processing target. The newly-added parameters account for only an extremely small part of overall model parameters, so that a parameter adjustment amount can be reduced, and parameter adjustment efficiency can be improved.

Because the newly-added parameters play a limited role in a model data processing process, in such a parameter adjustment manner, model knowledge learned by the model is limited, and it is difficult to bring good model processing performance.

### SUMMARY

To resolve the foregoing technical problem, this application provides a model training method and a related apparatus, to significantly improve model training accuracy in an incremental training scenario.

Embodiments of this application disclose the following technical solutions.

According to a first aspect, an embodiment of this application discloses a model training method, performed by a computer device, and including: obtaining a first model and sample data, the first model being trained based on initial sample data, and the sample data being different from the initial sample data; forming a second model by adding a plurality of incremental branches to the first model, the plurality of incremental branches and a main branch in the first model being configured to perform a same type of processing operation on same data, and an overall quantity of model parameters in the plurality of incremental branches being less than a quantity of model parameters in the main branch; determining, by using the second model based on the sample data, a pending processing result by combining processing results respectively corresponding to the plurality of incremental branches and the main branch; and adjusting the model parameters in the plurality of incremental branches based on a difference between the pending processing result and an annotation of the sample data, to obtain a third model.

According to a second aspect, an embodiment of this application discloses a model training apparatus, including an obtaining unit, a forming unit, a determining unit, and an adjusting unit, where the obtaining unit is configured to obtain a first model and sample data, the first model being trained based on initial sample data, and the sample data being different from the initial sample data; the forming unit is configured to form a second model by adding a plurality of incremental branches to the first model, the plurality of incremental branches and a main branch in the first model being configured to perform a same type of processing operation on same data, and an overall quantity of model parameters in the plurality of incremental branches being less than a quantity of model parameters in the main branch; the determining unit is configured to determine, by using the second model based on the sample data, a pending processing result by combining processing results respectively corresponding to the plurality of incremental branches and the main branch; and the adjusting unit is configured to adjust the model parameters in the plurality of incremental branches based on a difference between the pending processing result and an annotation of the sample data, to obtain a third model.

According to a third aspect, an embodiment of this application discloses a computer device, the computer device including a processor and a memory, where the memory is configured to store a computer program and transmit the computer program to the processor; and the processor is configured to perform, according to an instruction in the computer program, the model training method according to any one of the first aspect.

According to a fourth aspect, an embodiment of this application discloses a non-transitory computer-readable storage medium, the computer-readable storage medium being configured to store a computer program, the computer program being configured to perform the model training method according to any one of the first aspect.

It can be learned from the foregoing technical solutions that, when the third model configured for achieving a new data processing target needs to be obtained through training based on the first model, the plurality of incremental branches may be first added to the first model to form the second model, so that the second model has a plurality of processing branches. The plurality of processing branches includes the original main branch in the first model and the plurality of incremental branches, and the overall quantity of model parameters in the plurality of incremental branches is less than the quantity of model parameters in the main branch. In a training process, the model parameters in the plurality of incremental branches are adjusted, so that the second model can learn how to achieve the new data processing target. The plurality of incremental branches and the main branch in the first model are all configured to perform a same type of processing operation on same data. In a process of performing data processing on the sample data, the plurality of processing branches may independently perform data processing on input data, to obtain processing results respectively corresponding to the plurality of processing branches, and the second model may output a final pending processing result with reference to the plurality of processing results. The annotation corresponding to the sample data is a processing result obtained by performing accurate data processing on the sample data when the new data processing target is achieved. Therefore, by performing parameter adjustment on the model parameters in the plurality of incremental branches based on the difference between the pending processing result and the annotation, the second model can learn how to achieve the new data processing target. In a first aspect, in this application, during incremental training, the plurality of incremental branches are newly added, enriching a quantity of incremental model parameters. Therefore, a model knowledge learning capability brought by performing parameter adjustment on the incremental model parameter can be improved. In a second aspect, the plurality of incremental branches in this application can independently form a plurality of processing branches, perform data processing independently of each other, and complete a same processing operation. Therefore, under a small overall quantity of incremental model parameters, a data analysis process during data processing can still be enriched, thereby improving data processing accuracy. In a third aspect, in this application, during model parameter adjustment, only the incremental model parameters are adjusted, and the original model parameter of the first model remains unchanged. Therefore, while model knowledge of the first model is reserved, new model knowledge can be learned by using the incremental model parameter, thereby enriching a model knowledge amount, and further improving data processing accuracy. In addition, because the overall quantity of model parameters in the plurality of incremental branches is less than the quantity of model parameters in the main branch, a parameter adjustment amount needed in such a parameter adjustment manner is small, and model training efficiency is high. In a fourth aspect, because a model architecture with a plurality of processing branches in this application brings a better training effect, a data processing procedure for which the plurality of processing branches is constructed in this application may be a part of a processing procedure, that is, functioning only in a part of the model architecture can also ensure accuracy of overall data processing of the model.

### BRIEF DESCRIPTION OF THE DRAWINGS

To describe the technical solutions of the embodiments of this application or the related art more clearly, the following briefly introduces the accompanying drawings needed for describing the embodiments or the related art. Apparently, the accompanying drawings in the following descriptions show only some embodiments of this application, and a person of ordinary skill in the art may still derive other accompanying drawings from these accompanying drawings without creative efforts.

FIG. 1 is a schematic diagram of a model training method in an actual application scenario according to an embodiment of this application.

FIG. 2 is a flowchart of a model training method according to an embodiment of this application.

FIG. 3 is a schematic diagram of a model architecture according to an embodiment of this application.

FIG. 4 is a schematic diagram of a model architecture according to an embodiment of this application.

FIG. 5 is a schematic diagram of model parameter adjustment according to an embodiment of this application.

FIG. 6 is a schematic diagram of a model architecture according to an embodiment of this application.

FIG. 7 is a schematic diagram of a learning rate reduction policy according to an embodiment of this application.

FIG. 8 is a schematic diagram of a model architecture according to an embodiment of this application.

FIG. 9 is a flowchart of a model training method in an actual application scenario according to an embodiment of this application.

FIG. 10 is a schematic diagram of a model architecture in an actual application scenario according to an embodiment of this application.

FIG. 11 is a block diagram of a structure of a model training apparatus according to an embodiment of this application.

FIG. 12 is a diagram of a structure of a terminal according to an embodiment of this application.

FIG. 13 is a diagram of a structure of a server according to an embodiment of this application.

### DESCRIPTION OF EMBODIMENTS

The following describes the embodiments of this application with reference to the accompanying drawings.

In the data processing field, performing data processing by using a model is a common data processing manner. A data processing target that can be achieved by the model generally depends on a training manner for the model. For example, model training is performed by using sample data and a reference processing result obtained by performing a specified data processing task on the sample data, so that the model can learn how to accurately perform the data processing task.

However, a data processing target that the model needs to achieve during actual application may be different from a data processing target achieved in a training process. For example, in the training process, the model can only achieve data processing of first accuracy. However, during actual application, the model needs to achieve data processing of second accuracy. Alternatively, a data processing task performed by the model during actual application is different from a data processing task performed by the model in the training process. One example is an object recognition model. Object detection focuses on identifying specific target objects in an image and simultaneously determining each object's class and location (classification + localization). A typical model uses a classification head to predict the object category and a regression head to estimate its location. Object detection models develop a strong understanding of both the foreground and background so that they can separate objects of interest from surrounding context and determine each object's descriptive attributes (its class and position). The model’s output is generally a list, where each entry contains an array representing the detected object’s class and its location, commonly expressed using the coordinates of a bounding box. In the training process, a used training sample is mainly an image including a non-person object, and therefore, the model mainly learns how to perform object recognition on the non-person object in the image. However, during actual application, recognition may need to be performed on a person in the image by using the model. If object recognition is performed by still using the original model, inaccurate recognition may occur. Therefore, when the model needs to achieve a new data processing target, the model needs to learn model knowledge configured for achieving the new data processing target.

In the related art, to improve model training efficiency, an existing model parameter of a model may not be adjusted, but a small quantity of model parameters is newly added to the model. Parameter adjustment is performed on the newly added model parameters in a current training process by using sample data that is not used in an original training process, so that the model learns how to achieve a new data processing target. However, the quantity of the newly-added model parameters is small, and data processing can be performed only once in a data processing procedure. As a result, by adjusting the newly-added model parameters, model knowledge that can be learned by the model is limited. Consequently, it is difficult for the model to achieve the new data processing target.

To resolve the foregoing technical problem, this application provides a model training method. A plurality of incremental branches is added to form, together with an original main branch in a first model, a plurality of processing branches in a second model. When sample data configured for causing the second model to learn how to achieve a new data processing target is processed, the plurality of incremental branches and the main branch in the first model are all configured to perform a same type of processing operation on same data, to obtain processing results respectively corresponding to the plurality of incremental branches and the main branch in the first model. A processing result determined by the model may be outputted by combining processing results respectively corresponding to the plurality of processing branches. Because the plurality of processing branches are independent of each other in a data processing process, a processing dimension of data processing can be enriched by using the plurality of incremental branches. In this way, when model training is completed by adjusting model parameters in the plurality of incremental branches, the model can fully learn a data processing manner of a new data processing task, thereby improving processing accuracy of the model for the new data processing task without excessively increasing a quantity of model parameters.

The method may be applied to a computer device. The computer device is a computer device that can perform model training, for example, may be a terminal device or a server. The method may be performed independently by the terminal device or the server, or may be applied to a network scenario in which the terminal device communicates with the server, and is performed by a collaboration of the terminal device and the server. The terminal device may be a device such as a mobile phone, a tablet computer, a notebook computer, or a desktop computer. The terminal device may further include an augmented reality (AR) device such as AR glasses and an AR screen, and may include a virtual reality (VR) device such as head-mounted VR glasses. The server may be understood as an application server or a Web server. During actual deployment, the server may be a dedicated server, or may be a cluster server or a cloud server.

For ease of understanding the technical solutions provided in this application, the model training method provided in this application is described below with reference to an actual application scenario.

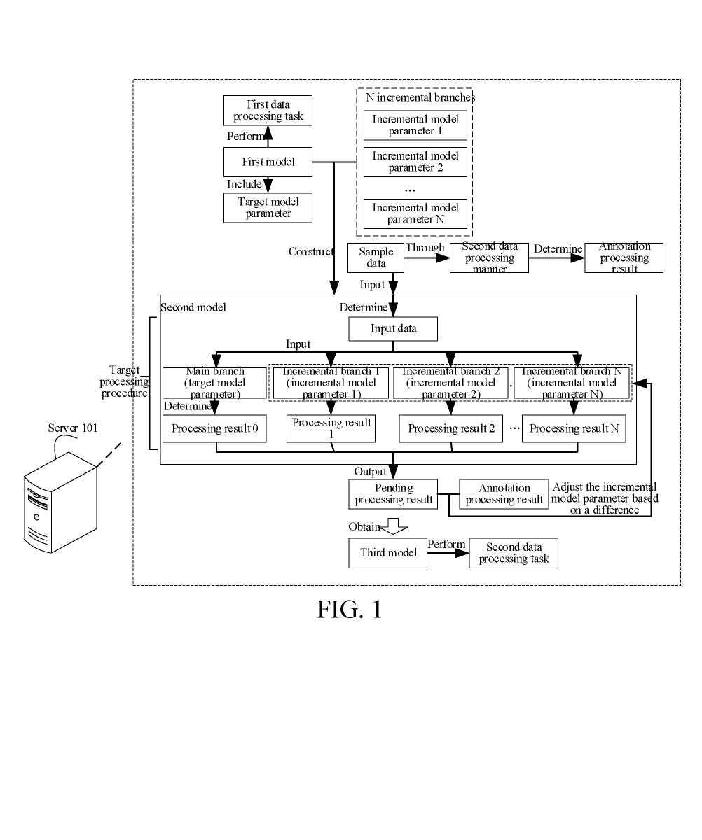

Refer to FIG. 1. FIG. 1 is a schematic diagram of a model training method in an actual application scenario according to an embodiment of this application. In the actual application scenario, a computer device may be a server 101 having a model training function, a first model is a model that can perform a first data processing task, and an objective of model training is to enable the first model to perform a second data processing task. The server 101 may first obtain the first model and sample data. The first model is configured to perform the first data processing task. The first data processing task may be, for example, an object recognition task for a non-person object. The sample data is to-be-processed data in the second data processing task. The second data processing task may be, for example, an object recognition task for a person. Correspondingly, the sample data may be an image including the person.

A second model may be formed based on the first model and N (N is an integer greater than 1) incremental branches. The second model is configured for learning how to perform the second data processing task. An incremental model parameter in each of the N incremental branches may be set in a plurality of manners. This is not limited herein. Model parameters of the second model include a target model parameter of the first model and the incremental model parameter in each of the N incremental branches. A main branch including the target model parameter of the first model and the N incremental branches jointly form the plurality of processing branches. The plurality of processing branches is configured to perform, independently of each other, a target processing procedure in the second data processing task by using a same type of processing operation. After the sample data is inputted into the second model, the second model determines input data corresponding to the target processing procedure. The input data is separately inputted into the plurality of processing branches, and each processing branch determines a corresponding processing result. The second model may combine processing results respectively determined by the plurality of processing branches, to determine a finally outputted pending processing result. The pending processing result is a processing result obtained by performing the second data processing task on the sample data by the second model.

In this application, the main branch in the first model and the N incremental branches may form the plurality of processing branches, to complete determining of the pending processing result in a mutually independent and parallel manner. Therefore, more detailed data processing can be performed for the target processing procedure by using a model architecture of the second model, thereby improving complexity of data analysis, and further improving data processing accuracy. The server 101 may obtain an annotation corresponding to the sample data. The annotation is a processing result obtained by accurately performing the second data processing task on the sample data. Therefore, based on a difference between the annotation and the pending processing result, processing accuracy of performing the second data processing task by the second model can be represented, and further, model parameters in the plurality of incremental branches may be adjusted, so that the second model learns how to accurately perform the second data processing task, to obtain a third model configured to perform the second data processing task.

In this application, by adding the plurality of incremental branches, complexity of data processing in which the model parameters corresponding to the incremental branches participate in the target processing procedure is improved. Therefore, even though an overall quantity of model parameters in the N incremental branches is still less than a quantity of target model parameters, a quantity of incremental model parameters is enriched in comparison with the related art. This can bring rich data processing performance to the target processing procedure. Further, performing parameter adjustment only on the model parameters in the incremental branches can reduce a model parameter adjustment amount and ensure effectiveness of model parameter adjustment, so that the second model can effectively learn how to accurately perform the second data processing task, and model knowledge that is configured to perform the first data processing task and that is in the first model can be retained for assisting the third model in performing the second data processing task.

Next, the technical solutions provided in this application are described in detail with reference to the accompanying drawings.

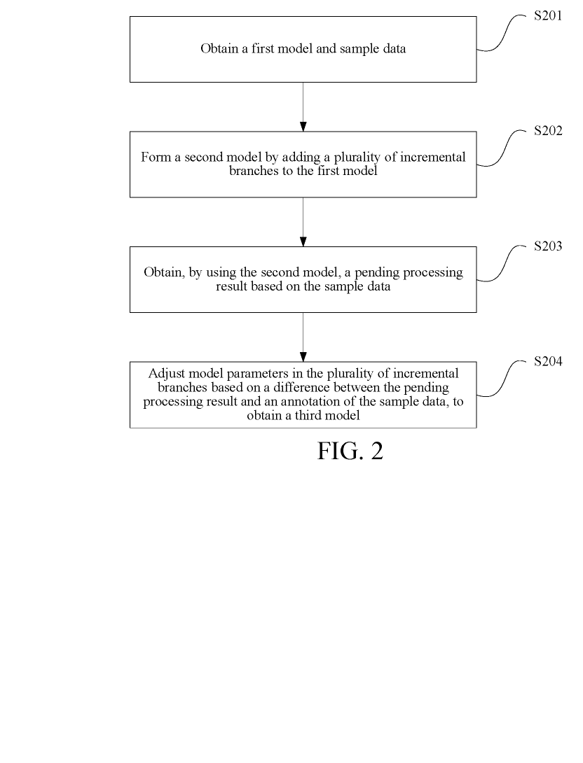

Refer to FIG. 2. FIG. 2 is a flowchart of a model training method according to an embodiment of this application. In this embodiment, a computer device configured to perform the model training method may be any computer device that can perform model training, and the method includes the following operations.

S201: Obtain a first model and sample data.

This application is mainly directed to an incremental training scenario, to be specific, a scenario in which a pre-trained model is trained again. The first model is configured for achieving an old data processing target, and an objective of incremental training is to obtain a model that can achieve a new data processing target. The new data processing target and the old data processing target may be different data processing targets. A data processing target that a model can achieve mainly depends on data used during training of the model. Therefore, to cause a third model obtained through incremental training to achieve a data processing target different from that achieved by the first model, when the first model is obtained through training based on initial sample data, sample data used during incremental training is different from the initial sample data.

Data processing targets may include targets in a plurality of dimensions. For example, two different data processing targets may refer to different achieving accuracy for a same data processing task. For example, an old data processing target is to be capable of achieving 80% accuracy in object recognition, and a new data processing target is to be capable of achieving 90% accuracy in object recognition. Alternatively, two different data processing targets may refer to achieving two different data processing tasks. For example, a possible old data processing target is to be capable of recognizing a person object in an image, and a possible new data processing target is to be capable of recognizing an animal object in an image. The model training method in this application is applicable to the foregoing plurality of scenarios. For ease of distinction, in this embodiment of this application, the old data processing target is referred to as a first data processing target, and the new data processing target is referred to as a second data processing target.

The first model may be any model. In a model training process corresponding to the first model, because the first model is obtained through training based on the initial sample data, the first model has model knowledge learned from the initial sample data and configured for achieving the old data processing target.

To cause the first model to learn how to achieve the new data processing target, the computer device may obtain new sample data. The new sample data has a corresponding annotation. The annotation may include ground truth label of the new sample data directed to the new data processing target. For example, when the second data processing target is to achieve higher accuracy than that of the first data processing target for a same data processing task, the new sample data may be sample data corresponding to the data processing task, and the annotation is a processing result obtained by accurately performing the data processing task on the new sample data. Because the new sample data and the annotation do not participate in the training process of the first model, the first model can learn model knowledge configured for accurately performing the new data processing task, thereby improving accuracy of performing the data processing task. Alternatively, when the second data processing target is to achieve a data processing task different from that of the first data processing target, the new sample data may be sample data in the data processing task corresponding to the second data processing target, in other words, the annotation corresponding to the sample data is a processing result obtained by accurately performing the data processing task on the sample data.

S202: Form a second model by adding a plurality of incremental branches to the first model.

It can be learned from the foregoing analysis that, reasons for an inaccurate model training manner in the related art mainly include the following two aspects.

1. A quantity of incremental model parameters is excessively small.

Because the quantity of parameters is excessively small, even if the incremental model parameter can be sufficiently adjusted, it is difficult for the model to learn model knowledge related to the new data processing target.

2. A data processing procedure in which the incremental model parameter participates is excessively simple.

In the related art, all incremental model parameters participate in only one data processing procedure in one data processing task. As a result, the data processing procedure based on the incremental model parameters is simple, and it is difficult to perform complex and detailed analysis on data. Consequently, it is difficult for a model trained in this manner to accurately perform the new data processing task.

In this application, to resolve the foregoing two technical defects, the second model may be constructed based on the plurality of incremental branches and the first model. Model parameters of the second model include a model parameter corresponding to the first model and a model parameter in each of the plurality of incremental branches, and an overall quantity of model parameters in the plurality of incremental branches is less than a quantity of model parameters in a main branch (namely, a branch corresponding to the first model). The second model includes a plurality of processing branches (to be specific, the main branch and the plurality of incremental branches), for example, as shown in FIG. 1. The plurality of incremental branches and the main branch in the first model are all configured to perform a same type of processing operation on same data, so as to perform a plurality of times of data processing for a same data processing procedure. The new data processing target is a data processing target achieved by performing the processing operation. In this application, while the quantity of incremental model parameters (namely, the model parameters in the plurality of incremental branches) is kept smaller than a quantity of parameters of the second model, a quantity of incremental model parameters is increased, and a model architecture related to the incremental model parameter in the second model is enriched, thereby bringing model architecture support for a complex processing procedure below.

Processing operations performed by the plurality of processing branches may be any procedure related to achieving the new data processing target, that is, all or a part of a processing procedure. A model parameter in the main branch is a model parameter that is in a first model parameter and that is configured to perform the processing operation.

An objective of configuring the plurality of incremental branches is to replace the original main branch in the first model to learn model knowledge. Therefore, in this application, the plurality of incremental branches and the main branch may perform a same data processing operation, in other words, data processing operations respectively performed by the plurality of processing branches are the same. A target processing branch is configured to perform, by using a model parameter corresponding to the target processing branch, the data processing operation on input data corresponding to the target processing procedure, to obtain a processing result corresponding to the target processing branch. For example, the data processing operation may be a feature extraction operation, to be specific, the plurality of processing branches each are configured to perform a feature extraction operation on the input data corresponding to the target processing procedure, to obtain a processing result corresponding to each processing branch. The target processing branch may be any one of the plurality of processing branches.

Because the incremental branch and the main branch perform the same data processing operation, adjusting the model parameter in the incremental branch in a model training process can effectively simulate a manner of adjusting the model parameter in the main branch, so that the second model can learn accurate model knowledge by adjusting the model parameter in the incremental branch, to accurately achieve the second data processing target.

A same data processing operation does not necessarily represent a same data processing manner. For example, both the main branch and the incremental branch may perform a feature extraction operation (which may be, for example, a convolution operation). However, the main branch directly performs feature extraction by using the model parameter in the main branch, and the incremental branch may perform, in the foregoing manner of reducing a quantity of parameters, feature extraction by using a first parameter and a second parameter. This also belongs to the same data processing operation described in this application.

S203: Obtain, by using the second model, a pending processing result based on the sample data.

The pending processing result is determined by combining processing results respectively corresponding to the plurality of processing branches. When the target processing procedure is performed, the plurality of processing branches performs data processing independently of each other. Therefore, even though a quantity of model parameters corresponding to each incremental branch is small, in other words, a data processing manner of each incremental branch is simple, detailed and complex data processing can be performed on the input data through combination of the plurality of incremental branches, so that the data processing result obtained through combination of the plurality of processing branches can support high accuracy and suitability. In other words, such a data processing manner can support the second model to effectively learn sufficient model knowledge by using the model parameter in the incremental branch, so as to effectively learn how to achieve the new data processing target.

In addition, because the plurality of processing branches performs data processing independently of each other, when performing a same processing operation, the plurality of processing branches may perform the same processing operation in parallel. In this way, efficiency of performing the data processing task by the second model is ensured. Further, model training efficiency can be ensured, and a loss of data processing efficiency caused by an increase in a quantity of model parameters in the incremental branch can be avoided.

S204: Adjust the model parameters in the plurality of incremental branches based on a difference between the pending processing result and the annotation of the sample data, to obtain the third model.

The model parameters in the plurality of incremental branches may also be referred to as incremental model parameters. Because the annotation is a processing result obtained by performing data processing on the sample data when the new data processing target is achieved, the difference between the annotation and the pending processing result can represent a discrepancy between a data processing target currently achieved by the second model and the new data processing target, and a larger difference indicates a larger discrepancy. Therefore, the computer device may perform parameter adjustment on the plurality of incremental model parameters based on the discrepancy, so that the second model learns how to determine, by using the incremental model parameters, the pending processing result close to the annotation, and therefore, the second model can learn, by adjusting the incremental model parameters, model knowledge configured for achieving the new data processing target, to obtain the third model. The third model may be configured for achieving the new data processing target. For example, training is performed by using new sample data of a same data processing task, so that the third model can achieve higher accuracy data processing for the data processing task. Alternatively, training is performed by using sample data corresponding to new data processing task, so that the third model can be configured to perform the new data processing task.

The incremental model parameters in this application can be configured to perform complex and detailed analysis on the sample data. Therefore, during model training, by adjusting only the incremental model parameters, sufficient model knowledge can be learned without overall adjustment on the original model parameter of the first model. Therefore, a parameter adjustment amount needed for the model training can be reduced to some extent, thereby improving model training efficiency.

In conclusion, this application can bring technical effects in the following plurality of aspects.

In a first aspect, in this application, during incremental training, the plurality of incremental branches are newly added, enriching the quantity of incremental model parameters. Therefore, a model knowledge learning capability brought by performing parameter adjustment on the incremental model parameter can be improved.

In a second aspect, the plurality of incremental branches and the original main branch in the first model in this application can independently form the plurality of processing branches, and can perform data processing independently of each other when performing a data processing procedure. Therefore, under a small overall quantity of incremental model parameters, a data analysis process during data processing can still be enriched, thereby improving data processing accuracy.

In a third aspect, the plurality of processing branches that are independent of each other may perform data processing in parallel. Therefore, even though the plurality of processing branches are added, data processing efficiency of the model is not significantly affected, thereby ensuring data processing efficiency of the model.

In a fourth aspect, in this application, during model parameter adjustment, only the incremental model parameters are adjusted, and the original model parameter of the first model remains unchanged. Therefore, while model knowledge of the first model is reserved, new model knowledge can be learned by using the incremental model parameter, thereby enriching a model knowledge amount, and further improving data processing accuracy.

In a fifth aspect, because the overall quantity of parameters in the plurality of incremental branches is less than the quantity of parameters of the first model, a parameter adjustment amount needed in such a parameter adjustment manner is small, and model training efficiency is high.

In a sixth aspect, in this application, because a model architecture with a plurality of processing branches brings a better training effect, a data processing procedure corresponding to the data processing operation performed by the plurality of processing branches constructed in this application may be a part of a complete data processing procedure, that is, functioning only in a part of the model architecture can also ensure accuracy of overall data processing of the model.

Because the incremental model parameter in this application supports a complex data processing function, the incremental model parameter in this application can bring high processing accuracy to the data processing task even though the incremental model parameter in this application participates only in a part of the processing procedure in the data processing task. Based on this, in one embodiment, the model parameter in the main branch is a part of model parameters in the first model, the processing operations performed by the plurality of processing branches are configured for completing a target processing procedure in the third model, and the target processing procedure may be a part of the processing procedure in the data processing task. Because participation in the entire processing procedure in the data processing task is not needed, a quantity of needed incremental model parameters is reduced to some extent, so that while the data processing accuracy is ensured, a quantity of model parameters that need to be adjusted for model training can be further reduced, thereby further improving the model training efficiency.

A plurality of data processing tasks may be applied to the third model in this application. Next, the model training method in this application is described with reference to a specific data processing task.

In a possible application scenario, the data processing task may be configured to perform, based on image information, object recognition on a target object included in the image information. The data processing task may include a feature extraction procedure, a location recognition procedure, and a category recognition procedure. The target processing procedure may include the location recognition procedure and the category recognition procedure.

The feature extraction procedure is configured for extracting image feature data corresponding to the image information. The image feature data is input data corresponding to the target processing procedure. The location recognition procedure is configured for determining corresponding location data of the target object in the image information based on the image feature data. For example, data such as a bounding box corresponding to the target object in the image information may be determined. The category recognition procedure is configured for determining object category data corresponding to the target object based on the image feature data. For example, an object identity, an object category and a biological category corresponding to the object, and the like may be recognized. Under participation of the plurality of incremental branches, accurate data processing can be performed in both the location recognition procedure and the category recognition procedure in the second model. Therefore, even if the feature extraction procedure is not adjusted, an accurate object recognition capability can be brought, and training efficiency of a model for object recognition is improved while an object recognition accuracy is ensured. Therefore, when a data processing target changes, for example, object recognition accuracy or an application scenario of object recognition changes, an object recognition model that can accurately achieve a new data processing target can be quickly obtained through training in the model training manner of this application.

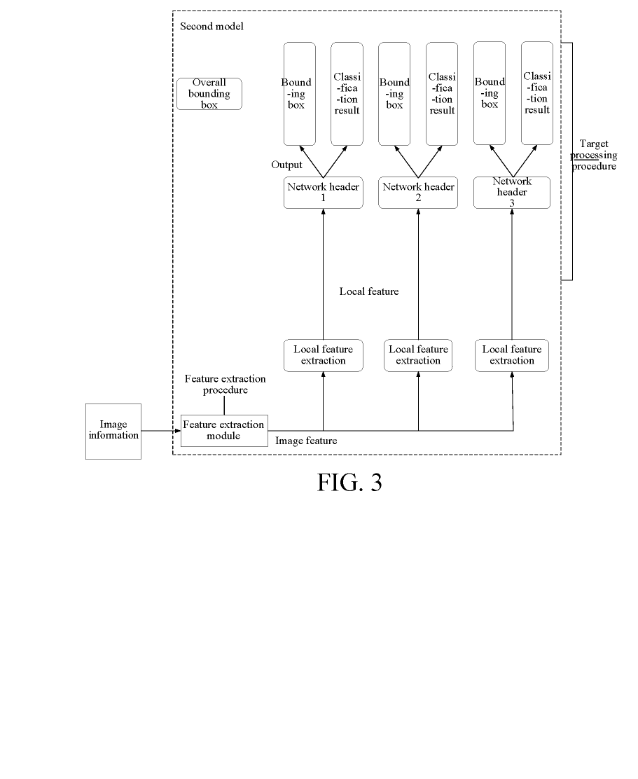

A model architecture of the initial model may be shown in FIG. 3. After the image information is inputted, a complete image feature is first extracted by using a feature extraction module corresponding to the feature extraction procedure. The feature extraction module may be formed by using a backbone network. The backbone network may use various networks. For example, in this application, a parallel high-resolution network (HRNetV2P) may be used as the backbone network. Compared with a residual neural network (ResNet), a high-resolution network (HRNet) has a stronger capability of extracting panoramic information.

A local feature extraction module is configured for extracting a local feature from the image feature and inputting the local feature into each network header. Local feature extraction may be implemented by using a local feature extractor pool. The network header is configured to perform the foregoing target processing procedure. The network header includes a classification header and a regression header. The classification header is configured for obtaining category information, and determining a classification result corresponding to the local feature. The regression header is configured for determining location information, and outputting a bounding box corresponding to an object. Overall bounding boxes are bounding boxes that respectively correspond to a plurality of objects in the image information and that are obtained by performing overall location recognition on the image information by the second model, and are configured for guiding an extraction manner of local feature extraction.

In one embodiment, when a data processing task of the third model is image recognition, the sample data configured for training the second model and the initial sample data configured for training the first model may both be images. The first model is configured for recognizing a category of a first object in the initial sample data. In other words, when the first model is trained by using the initial sample data, the first model is enabled to have a recognition capability of recognizing the category of the first object in the initial sample data. In this implementation, an objective of incremental training is to enable the second model to have a stronger category recognition capability. For example, the third model obtained by training the second model may be configured for recognizing the category of the first object in the initial sample data and a category of a second object in the sample data, in other words, have both an object recognition capability of the first model and a new object recognition capability for the second object.

The first object and the second object may be objects of a same category, or may be objects of different categories. For example, an objective of incremental training may be to enable a model to recognize more classes for objects of a same category. For example, for objects of a "cat" category, the first model may only be capable of recognizing an orange cat class and a tabby cat class, and the sample data and the annotation provide, for the second model, a capability of recognizing a Siamese cat class. Alternatively, an objective of incremental training may be to enable the third model obtained through training to perform recognition on a new category of object. For example, the first model is configured to perform category recognition on an object of the category "cat", and after model training is performed by using the sample data and the annotation, the third model may be enabled to have a capability of recognizing an object of a category "dog".

Next, technical details related to the model training process are described in detail.

In one embodiment, to further reduce a model parameter adjustment amount in the training process and improve model training efficiency, the computer device may simulate, in a parameter splitting manner, a large incremental branch by using a plurality of sub-branches, to reduce the quantity of incremental model parameters.

Using a target incremental branch as an example, the target incremental branch may be any one of the plurality of incremental branches, the target incremental branch includes a first sub-branch and a second sub-branch, and model parameters in the target incremental branch include a first parameter in the first sub-branch and a second parameter in the second sub-branch. To enable a processing result corresponding to the target incremental branch to be combined with a processing result corresponding to the main branch, the processing results corresponding to the two branches need to have a same data dimension, for example, need to have a same feature dimension. Because inputs of the plurality of processing branches are same input data, the model parameter corresponding to the target incremental branch needs to have a same dimension as the model parameter in the main branch, in other words, the first parameter and the second parameter are configured for simulating an equivalent model parameter having the same dimension as the model parameter in the main branch.

When performing operation S203, the computer device may perform operations S2031 to S2033 (not shown in the figure), and operations S2031 to S2033 are one embodiment of operation S203, including:

S2031: Determine the input data of the plurality of processing branches based on the sample data.

When the target processing procedure corresponding to the processing operations performed by the plurality of processing branches is the entire processing procedure in the data processing task, the input data may be the input data itself. When the target processing procedure is a part of the processing procedure in the data processing task, the input data may be the input data itself, or may be data obtained by processing the sample data by using another processing procedure in the data processing task, for example, the image feature obtained through feature extraction in the foregoing content.

S2032: Determine, by using the plurality of processing branches and based on the input data, the processing results respectively corresponding to the plurality of processing branches.

The plurality of processing branches include the foregoing main branch and the plurality of incremental branches. The main branch is configured for determining the processing result corresponding to the main branch based on the model parameter in the main branch and the input data. The target incremental branch is configured for determining first intermediate data based on the input data and the first parameter, and determining the processing result corresponding to the target incremental branch based on the first intermediate data and the second parameter. The processing results respectively corresponding to the plurality of processing branches have a same data dimension.

In other words, for the target incremental branch, sequentially processing the input data by using the first sub-branch including the first parameter and the second sub-branch including the second parameter, can simulate an effect of processing the input data by using an equivalent model parameter whose format dimension is the same as that of the model parameter in the main branch, to obtain a processing result with the same data dimension, so that the processing result corresponding to the target incremental branch can be combined with the processing result corresponding to the main branch, to obtain a final processing result. A sum of a quantity of first parameters and a quantity of second parameters may be less than a quantity of equivalent model parameters. Therefore, replacing the equivalent model parameter with the first parameter and the second parameter can further reduce a quantity of model parameters in each incremental branch, and the same data dimension also ensures effectiveness of data processing, thereby improving model training efficiency.

S2033: Determine a pending processing result by combining the processing results respectively corresponding to the plurality of processing branches.

There may be a plurality of manners of simulating one branch by using a plurality of sub-branches to reduce a quantity of model parameters. A specific simulation manner is described below.

In one embodiment, the input data is n-dimensional feature data, and the processing results respectively corresponding to the plurality of processing branches all are m-dimensional feature data. Therefore, processing the input data into the processing result needs a model parameter that can be configured to perform n-dimensional to m-dimensional transformation. Because dimensions of the input data and the processing result are generally high, if n-dimensional to m-dimensional transformation is directly completed by using a single branch, a quantity of model parameters in the branch needs to be large. For example, the model parameters need to be an n*m matrix.

To reduce the quantity of model parameters in the incremental branch and enable the incremental branch to have the foregoing dimension transformation effect, the computer device may split, into two lower-dimensional model parameters, that is, the first parameter and the second parameter, a model parameter that is of the incremental branch and that is configured for n-dimensional to m-dimensional transformation. The first intermediate data is r-dimensional feature data. r is less than n and m. The first parameter is configured to perform dimensionality reduction processing on the input data, to determine first intermediate data, and the second parameter is configured to perform dimensionality expansion processing on the first intermediate data, to determine the processing result corresponding to the target incremental branch. Because in a data processing process, dimensions of related data are reduced, the first parameter and the second parameter may have small parameter quantities, so that a parameter effect of an original n*m-dimensional model parameter can be simulated while the quantity of model parameters in the incremental branch is reduced, thereby maintaining data processing performance of the incremental branch. In addition, because in this application, the quantity of incremental branches is large, using the parameter reduction method in this application can bring a more significant reduction in the quantity of parameters while model performance is ensured, so that the model training method in this application does not bring an excessively large increase in the quantity of model parameters, thereby ensuring model training efficiency.

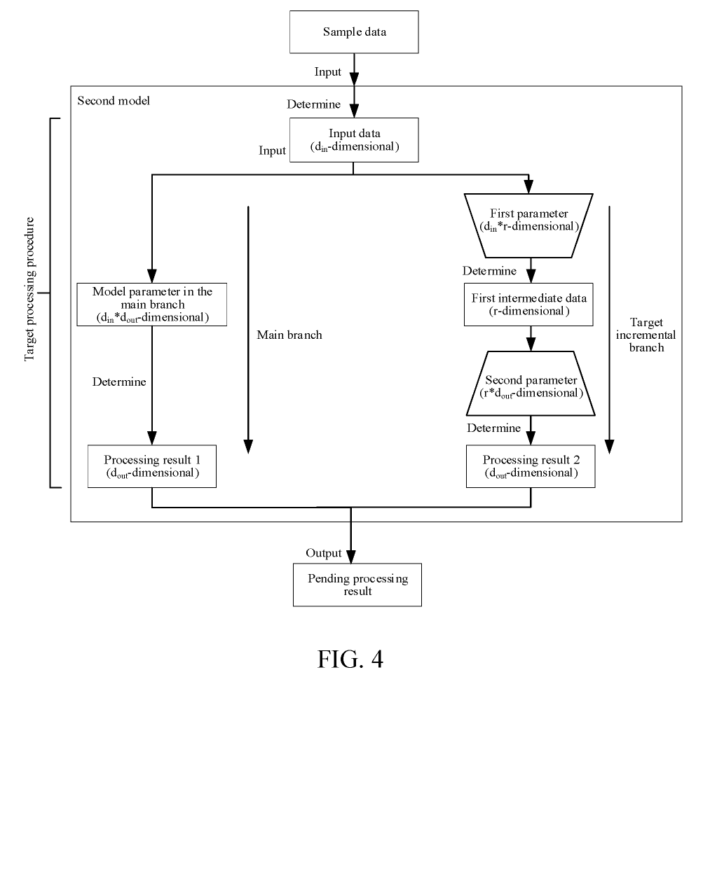

For example, as shown in FIG. 4, input data is data of dimension din-dimensional data, and a model parameter in a main branch is a din*dout-dimensional parameter, and a dout-dimensional processing result 1 may be directly determined by using the model parameter. A first parameter in a target incremental branch is a din*r-dimensional parameter. r-dimensional first intermediate data can be obtained by performing dimensionality reduction processing on the input data by using a first parameter. A dout-dimensional processing result 2 can be obtained by performing dimensionality expansion processing on the first intermediate data by using an r*dout-dimensional second parameter. Because r is less than dout, a sum of a quantity of first parameters and a quantity of second parameters is far less than a quantity of din*dout-dimensional model parameters, so that a quantity of incremental model parameters can be further reduced while effectiveness of a data processing procedure is maintained. The first parameter and the second parameter both may be matrix parameters. The first parameter may be initialized by using a Kaiming uniform distribution initialization method (for example, a zero-mean Gaussian distribution and a zero-mean and zero-variance uniform distribution for biases may be used). A quantity of output channels of a convolution kernel is specified as r, and the second parameter may be a 1*1 convolution. An r-dimensional feature is expanded to a dout-dimensional feature, for combination with the processing result of the main branch.

Next, a specific manner of model parameter adjustment is described for the foregoing data processing manner. When performing operation S204, the computer device may perform operations S2041 to S2044 (not shown in the figure), and operations S2041 and S2042 are one embodiment of operation S204, including:

S2041: Adjust the second parameter based on the difference between the pending processing result and the annotation of the sample data, and adjust the first intermediate data based on the difference between the pending processing result and the annotation of the sample data, to obtain second intermediate data.

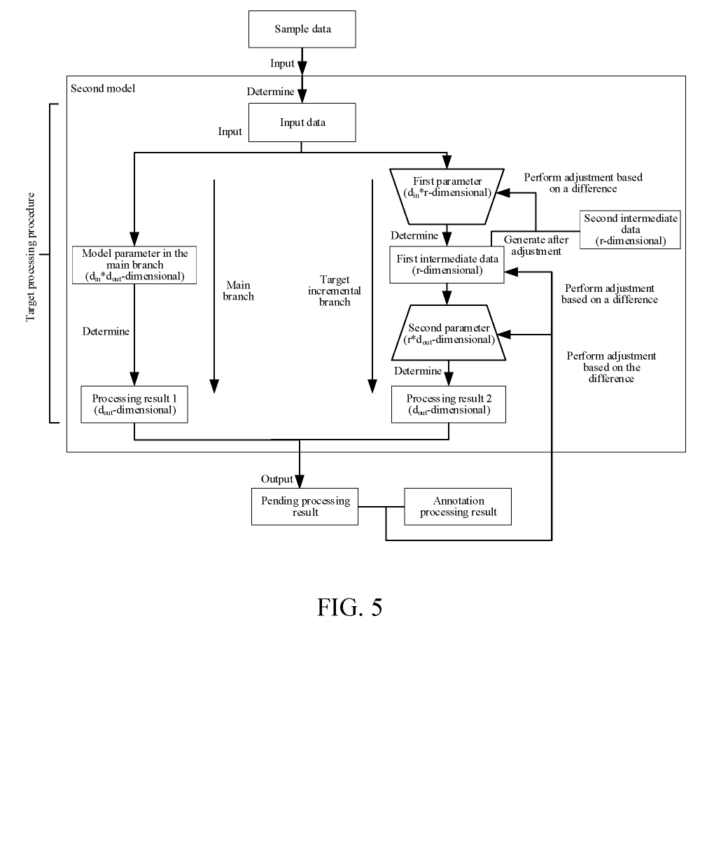

As shown in FIG. 5, the pending processing result is determined based on two aspects of data: the first intermediate data determined by using the first parameter; and the second parameter. Therefore, based on the difference, the computer device may first learn how to adjust the pending processing result, to make the pending processing result closer to the annotation, and may further determine, through gradient propagation, how to adjust the second parameter and the first intermediate data to meet an adjustment manner for the pending processing result. In this way, the second parameter and the first intermediate data may be adjusted based on the difference between the pending processing result and the annotation. The second intermediate data meeting an adjustment requirement may be obtained based on the adjustment on the first intermediate data.

S2042: Adjust the first parameter based on a difference between the second intermediate data and the first intermediate data.

The first intermediate data is determined based on two aspects of data: the first parameter; and the input data. Because the input data is unrelated to the model parameter in the incremental branch, in this application, the first parameter is mainly adjusted to make the determined first intermediate data meet the adjustment manner needed for the pending processing result, that is, the second intermediate data is obtained by adjusting the first parameter. Therefore, an adjustment manner for the first parameter may be determined based on the difference between the first intermediate data and the second intermediate date. The adjustment manner satisfies that the determined first intermediate data gradually approaches the second intermediate data, thereby causing the pending processing result to gradually approach a reference processing result.

In the foregoing manner, the difference between the pending processing result and the annotation may be transmitted to the first parameter and the second parameter through layer-by-layer gradient propagation, so that the computer device learns how to adjust the first parameter and the second parameter to make the target processing procedure more accurate, and further can more effectively learn, by adjusting the model parameter in the incremental branch, how to achieve the second data processing target.

As described above, in this application, data processing complexity and accuracy can be improved in a data processing manner of using the plurality of incremental branches. Therefore, in this application, even if data processing accuracy for each incremental branch is reduced to some extent, the accuracy loss can be compensated for through combination of the plurality of incremental branches, thereby ensuring a data processing effect of the model. Based on this, in one embodiment, to further improve model training efficiency, the computer device may reduce a data processing amount in the incremental branch.

In this implementation, the main branch is specifically configured for: performing feature extraction on the input data, to generate the processing result corresponding to the main branch, the processing result corresponding to the main branch being feature data having a first feature size.

Using the target incremental branch as an example, the target incremental branch is specifically configured for:

performing, by using the first sub-branch, feature extraction on the input data based on the first parameter, to generate the first intermediate data, the first intermediate data being feature data having a second feature size. A calculation amount needed for the feature extraction is positively correlated with a feature size corresponding to the generated feature data (that is, the second feature size). In other words, a larger extracted feature size indicates a larger calculation amount. Because the second feature size is smaller than the first feature size, when feature extraction is performed based on the first parameter, the calculation amount needed for the feature extraction can be reduced. Although a decrease in the calculation amount results in a decrease in data processing accuracy of the model to some extent, there are the plurality of incremental branches in this application. Combining mutually independent data processing functions of the plurality of incremental branches can compensate for an accuracy loss in a single incremental branch to some extent, thereby ensuring overall data processing accuracy.

Then, the target incremental branch may perform, by using the second sub-branch, data processing on the first intermediate data based on the second parameter, to determine the processing result corresponding to the target incremental branch. The data processing includes size upscaling processing for upscaling a feature size. In other words, size restoration is to be performed on the first intermediate data in a process of determining the processing result. That is, the processing result is feature data having the first feature size. A function of the second parameter is to perform data processing on the first intermediate data, so as to determine a more accurate model output based on data obtained through the processing, rather than to perform size restoration. That is, functions of the second sub-branch include two aspects: The second sub-branch can perform data processing; and the second sub-branch needs to perform size restoration. Because the size restoration only needs simple linear data calculation, a calculation amount needed in a restoration process is small, and a calculation amount for each incremental branch can still be significantly reduced on the whole. In addition, in the incremental branch, the feature size of the intermediate data related to the data processing process is downscaled. It can be learned from the foregoing process that, the difference between the intermediate data is one of the bases for adjusting the incremental model parameter, and downscaling the feature size results in a smaller difference between the intermediate data, so that the adjustment amount needed for model parameter adjustment can be reduced to some extent, and a model fitting speed can be improved, thereby further improving model training efficiency.

Because a correlation between the second parameter–based data processing and the size restoration is low, a sequence of the data processing and the size restoration is not limited in this application, and technical solutions and technical effects under different sequences are described in detail below.

First type: First restoration and then processing

In one embodiment, when performing data processing on the first intermediate data based on the second parameter to determine the processing result corresponding to the target incremental branch, the computer device may first perform size upscaling processing on the first intermediate data to generate third intermediate data. The third intermediate data is feature data having the first feature size. Then, the computer device determines, based on the third intermediate data and the second parameter, the processing result corresponding to the target incremental branch, in other words, performs data processing on the third intermediate data by using the second parameter, to obtain the processing result corresponding to the target incremental branch.

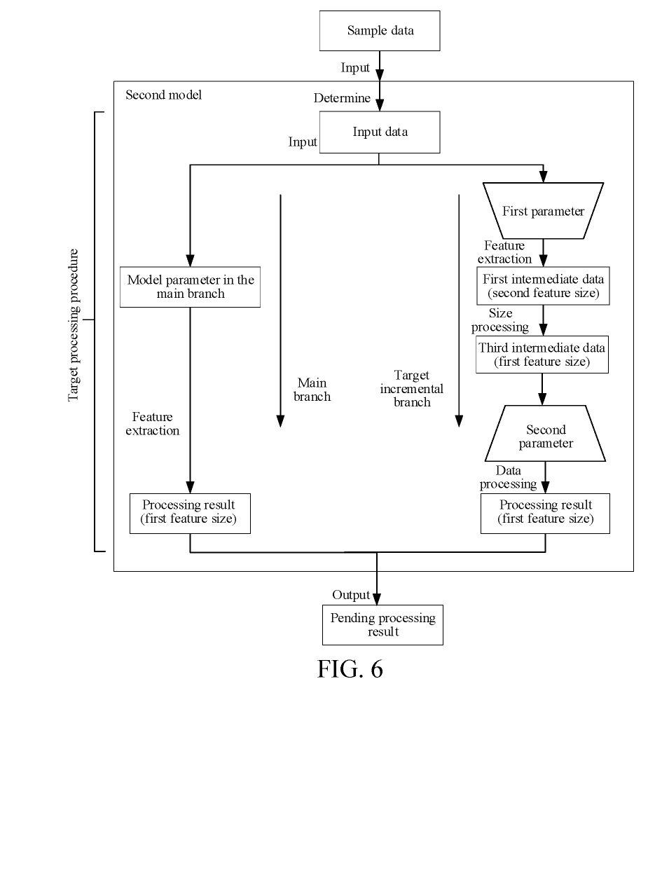

Advantages of this manner are as follows: Because the second parameter is configured to perform data processing on the third intermediate data having the relatively large first feature size, data processing on the third intermediate data is more complex and detailed, and processing accuracy of performing data processing by using the second parameter can be improved to some extent, thereby improving data processing accuracy of the target incremental branch. The processing process is shown in FIG. 6.

There may be a plurality of specific manners of perform feature extraction and size restoration. The following mainly describes a convolution processing manner.

In one embodiment, in the main branch, when performing feature extraction on the input data to generate the processing result corresponding to the main branch, the computer device may perform feature extraction on the input data through p times of convolution processing, to generate the processing result corresponding to the main branch. The quantity of times of the convolution processing determines a calculation amount needed for the convolution processing. A larger quantity of times results in a larger calculation amount, and consequently, a larger feature size is obtained.

In the target incremental branch, when performing feature extraction on the input data based on the first parameter to generate the first intermediate data, the computer device may perform, through q times of convolution processing, feature extraction on the input data based on the first parameter, to generate the first intermediate data. q is less than p. In other words, the quantity of times of convolution processing in the incremental branch is less than the quantity of times of convolution processing in the main branch. Therefore, a calculation amount needed for the incremental branch is less. The quantity of convolutions may be adjusted by adjusting a stride parameter during the convolution processing. A larger stride parameter results in a larger cross-span of each convolution processing in data. Consequently, a quantity of times of needed convolution processing is needed, and a smaller feature size is obtained. For example, by adjusting the stride parameter to four-fold stride parameter corresponding to the main branch, four-fold upsampling may be implemented during the convolution processing, to obtain the first intermediate data whose feature size is 1/16 of the feature size corresponding to the processing result of the main branch.

The size upscaling processing may include bilinear interpolation upsampling processing. The processing manner is a simple linear processing manner, requiring no participation of other parameters than the first intermediate parameter, and therefore has a small calculation amount and high processing efficiency. For example, the computer device may upscale a feature size to 16 times the original size through bilinear difference upsampling processing, to obtain the third intermediate data.

Second type: First processing and then restoration

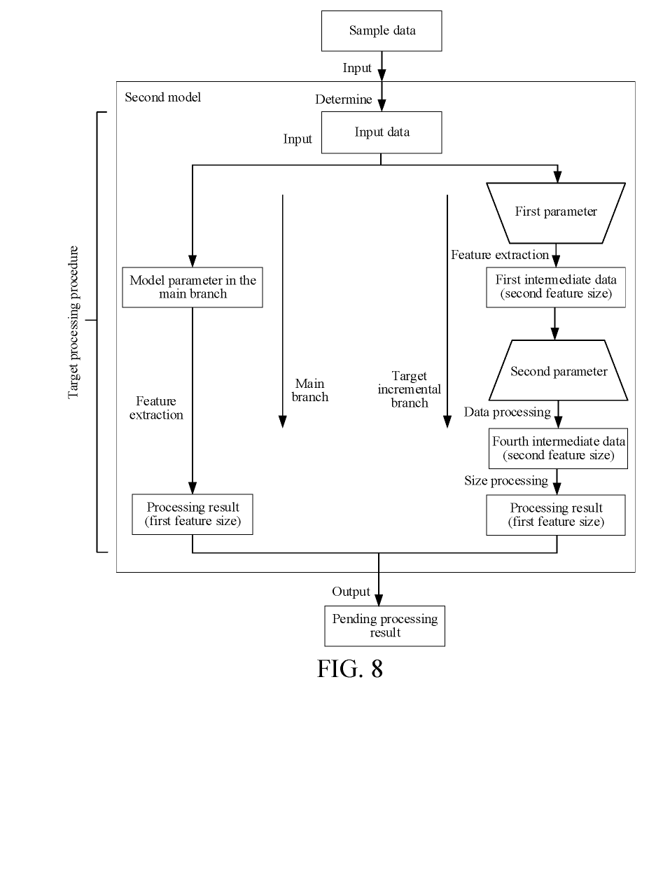

In another embodiment, as shown in FIG. 8, when performing data processing on the first intermediate data based on the second parameter to determine the processing result corresponding to the target incremental branch, the computer device may first determine fourth intermediate data based on the first intermediate data and the second parameter. The fourth intermediate data is feature data having the second feature size. That is, when processing the first intermediate data based on the second parameter, the computer device does not upscale the feature size of the first intermediate data, and perform only data processing. After completing the processing by using the second parameter, the computer device performs size upscaling processing on the fourth intermediate data, to generate the processing result corresponding to the target incremental branch, that is, obtain the processing result having the first feature size.

Advantages of this manner are as follows: A calculation amount needed for data processing is small because the feature size corresponding to the data that needs to be processed by using the second parameter is small. A calculation amount for feature restoration is not directly related to whether data processing is performed by using the second parameter. Therefore, this manner can further reduce the calculation amount needed for data processing by the target incremental branch, thereby further improving model training efficiency.

Next, a specific method for model parameter adjustment is described.

As described above, in this application, complexity and accuracy of data processing can be improved by adding the plurality of incremental branches, and more detailed data processing can be performed. However, the model parameters in the plurality of incremental branches are independent of each other, and the quantity of model parameters in each incremental branch is small. Therefore, during model parameter adjustment, a parameter adjustment amount needed for the model parameter in each incremental branch is small, thereby lowering difficulty in model parameter fitting. Based on this, in one embodiment, to further improve model training accuracy and model training efficiency, the computer device may progressively lower a learning rate of the model parameter in a parameter adjustment process, to obtain an effective model parameter more quickly.

When performing operation S204, the computer device may perform operation S2045 (not shown in the figure), and operation S2045 is one embodiment of operation S204, including:

S2045: Perform a plurality of rounds of parameter adjustment on the model parameters in the plurality of incremental branches based on the difference between the pending processing result and the annotation of the sample data.

The plurality of rounds of parameter adjustment each have a corresponding learning rate, and the learning rate decreases as a quantity of rounds of parameter adjustment increases. Using a target round of parameter adjustment as an example, the target round of parameter adjustment is any one of the plurality of rounds of parameter adjustment. A learning rate corresponding to the target round of parameter adjustment is configured for controlling adjustment magnitude of the model parameters in the plurality of incremental branches, and the learning rate corresponding to the target round of parameter adjustment is positively correlated with the adjustment magnitude. Because the quantity of model parameters in each incremental branch is small, the needed parameter adjustment amount is small. Small adjustment magnitude helps more efficiently find an incremental model parameter suitable for performing a data processing task, so that a model fitting speed can be further improved by gradually reducing a learning rate in an adjustment process, and training can be performed more efficiently to obtain a target model configured for achieving the second data processing target.

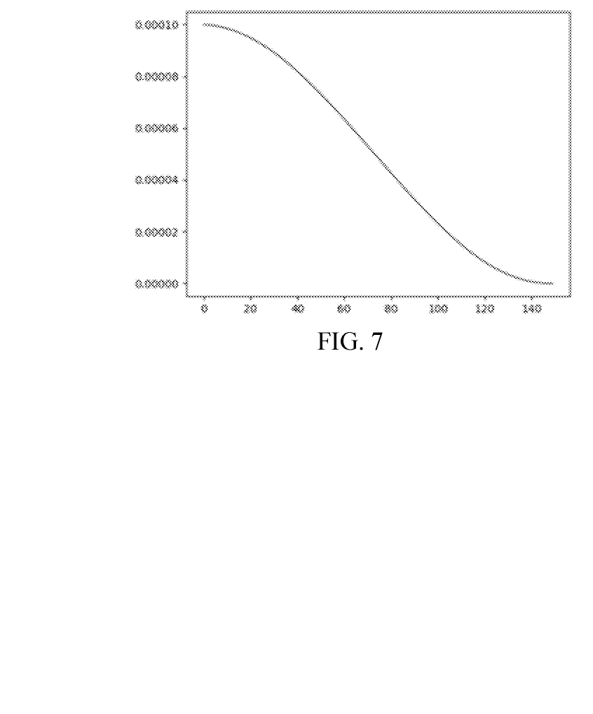

In addition, because the needed parameter adjustment amount is small, the computer device may limit a quantity of rounds of parameter adjustment into a small range. For example, in the related art, because a parameter adjustment amount is not reduced, 36 rounds of parameter adjustment may be needed to implement effective model training. In this application, because the parameter adjustment amount is reduced, the quantity of rounds of parameter adjustment may be reduced from 36 to 12, an initial value of the learning rate is adjusted to 1/10 of the original learning rate, and the learning rate gradually decreases in 12 rounds of parameter adjustment. A learning rate decreasing policy may adopt various policies, for example, a cosine annealing learning rate adjustment policy (Cosine AnnealingLR). A manner in which a learning rate controlled by using policy changes in a plurality of rounds of parameter adjustment is shown in FIG. 7. A horizontal coordinate is quantity of rounds of parameter adjustment, and a vertical coordinate is learning rate.

In addition, because the model parameters in the plurality of incremental branches are independent of each other, the plurality of incremental branches may perform data processing in parallel to improve data processing efficiency in a data processing process, and may also perform processing in parallel in a parameter adjustment process. In one embodiment, when performing operation S204, the computer device may perform operation S2046 (not shown in the figure), and operation S2046 is one embodiment of operation S204, including:

S2046: Adjust the model parameters in the plurality of incremental branches in parallel based on the difference between the pending processing result and the annotation corresponding to the sample data, to obtain the third model.

The computer device may adjust the model parameters in the plurality of incremental branches in parallel, to multiplicatively reduce time needed for the parameter adjustment, thereby ensuring model training efficiency even as the quantity of incremental model parameters multiplicatively increases.

For ease of understanding the technical solutions provided in this application, the model training method provided in this application is described below with reference to an actual application scenario.

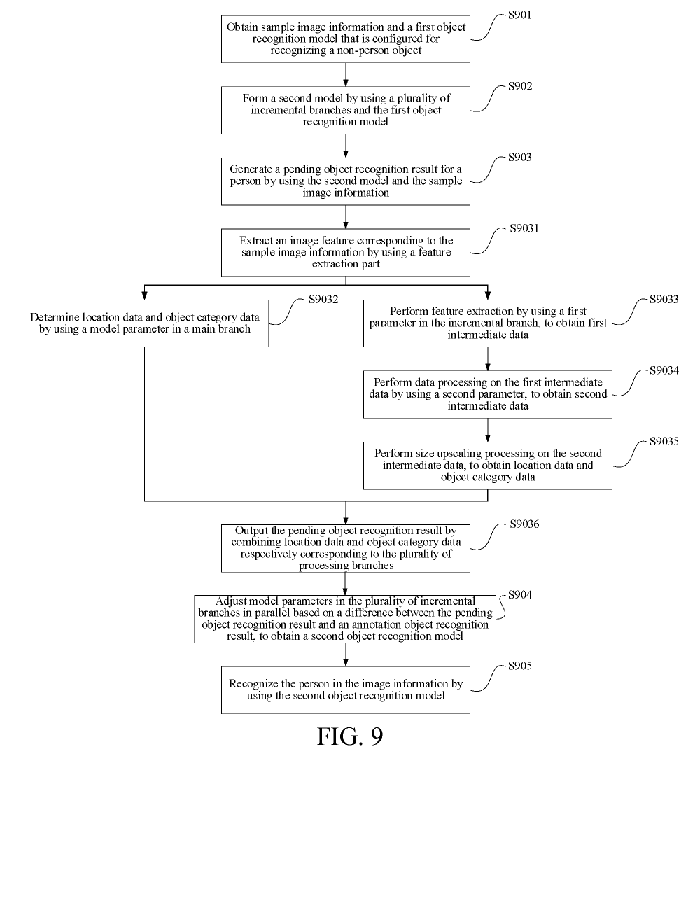

Refer to FIG. 9. FIG. 9 is a flowchart of a model training method in an actual application scenario according to an embodiment of this application. In the actual application scenario, a computer device may be any computer device that can perform model training, an objective of incremental training is to enable a third model obtained through training to perform a new data processing task, and the method includes the following operations.

S901: Obtain sample image information and a first object recognition model that is configured for recognizing a non-person object.

In the actual application scenario, a data processing task performed by the first object recognition model (namely, a first model) is recognizing a non-person object in image information, and a new data processing task is recognizing a person in image information. The first object recognition model is configured for recognizing the object, for example, a vehicle or a house, in the image information. The sample image information is image information including a person, the sample image information has a corresponding object annotation, and the object annotation is a result that accurately recognizes the person in the sample image information.

S902: Form a second model by using a plurality of incremental branches and the first object recognition model.

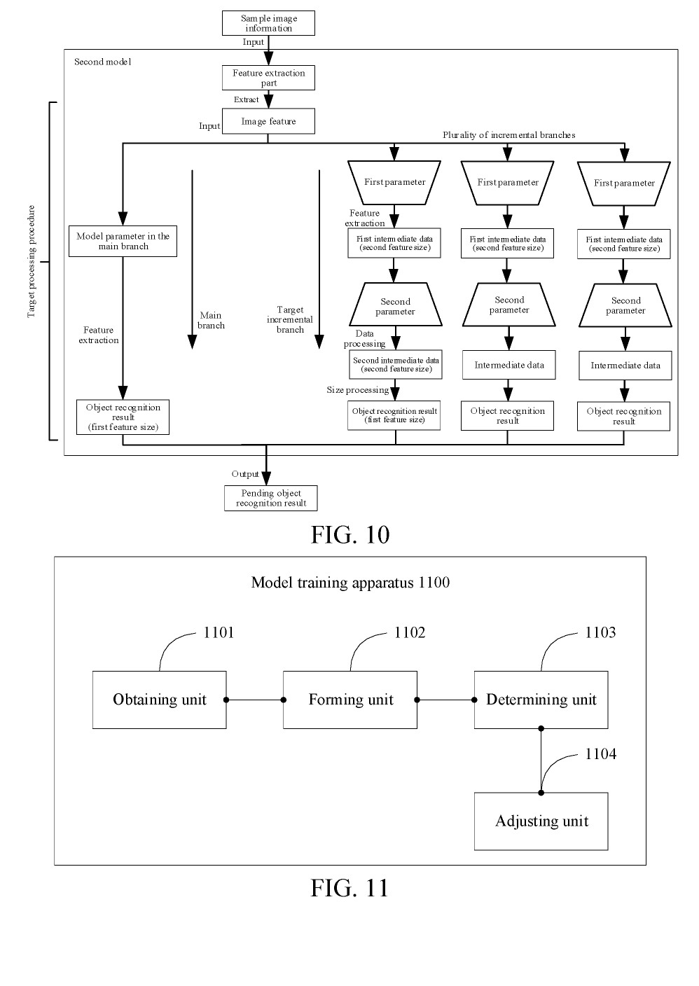

An architecture of the second model in this actual application scenario may be shown in FIG. 10. The plurality of incremental branches each have a corresponding first parameter and second parameter, to form a first sub-branch and a second sub-branch in each incremental branch, and the first sub-branch and the second sub-branch in each incremental branch and a model parameter in the first object recognition model jointly form a plurality of processing branches. The plurality of processing branches is configured for determining an object recognition result based on an image feature. The object recognition result includes location data and object category data. For example, the model parameter in the incremental branch and a model parameter in a main branch are model parameters in a regression head and a classification head.

S903: Generate a pending object recognition result for the person by using the second model and the sample image information.

A data processing procedure of operation S903 may be shown in operations S9031 to S9036.

S9031: Extract an image feature corresponding to the sample image information by using a feature extraction part.

The feature extraction part is configured for extracting an image feature corresponding to image information. The feature extraction part may adopt various feature extraction networks, for example, may be a ResNet network and a visual geometry group network. This is not limited herein.

S9032: Determine location data and object category data by using the model parameter in the main branch.

The location data and the object category data are an object recognition result corresponding to the main branch, and are data corresponding to a first feature size. The main branch is configured to perform a plurality of times of convolution processing on the image feature.

S9033: Perform feature extraction by using the first parameter in the incremental branch, to obtain first intermediate data.

A data processing procedure of the incremental branch is described by using a target incremental branch as an example. The first parameter is configured to perform a plurality of times of convolution processing on the image feature, to complete feature extraction. A quantity of processing times of the convolution processing is less than a quantity of processing times of convolution processing in the main branch, so that the first intermediate data of a second feature size can be obtained. Size scaling may be performed at multiple rates, for example, 1/2, 1/4, and 16/1. This is not limited herein.

The first parameter is a din*r-dimensional model parameter, the second parameter is a r*dout-dimensional model parameter, the image feature is a din-dimensional feature, an object recognition result outputted by the processing branch is dout-dimensional data, and r is less than dout, so that a sum of a quantity of first parameters and a quantity of second parameters is far less than a quantity of model parameters in the main branch.

S9034: Perform data processing on the first intermediate data by using the second parameter, to obtain second intermediate data.

The data processing may also be convolution processing, for further analyzing the first intermediate data, and expanding the data to dout-dimensional data.

S9035: Perform size upscaling processing on the second intermediate data, to obtain location data and object category data.

The size processing is for adjusting a feature size of the second intermediate data to the first feature size, to obtain an object recognition result outputted by the target incremental branch, that is, the location data and the object category data.

S9036: Output the pending object recognition result by combining location data and object category data respectively corresponding to the plurality of processing branches.

S904: Adjust model parameters in the plurality of incremental branches in parallel based on a difference between the pending object recognition result and an object annotation, to obtain a second object recognition model (namely, the foregoing third model).

When adjusting the model parameter, the computer device may adjust the model parameter by using a small quantity of rounds of adjustment, for example, may be completed by using 12 rounds of parameter adjustment. A learning rate of parameter adjustment gradually decreases as a quantity of rounds of parameter adjustment increases. various learning rate decreasing policies may be used, such as a Cosine AnnealingLR policy and a distribution policy (MultiStep). This is not limited herein. An adjusted incremental model parameter in this application may be configured not only for a network header, but also for a part of a procedure in the feature extraction part, and the like, for example, may be configured for the fourth stage in four stages of a backbone network of the feature extraction part. None of original model parameters of the first object recognition model is adjusted.

S905: Recognize the person in the image information by using the second object recognition model.

It can be learned from the foregoing process that, compared with the related art, this application has outstanding technical effects in the following plurality of aspects.
1. In this application, during incremental training, the plurality of incremental branches are newly added, enriching a quantity of incremental model parameters. Therefore, a model knowledge learning capability brought by performing parameter adjustment on the incremental branches can be improved. Adding an incremental model parameter only to a network header part can also bring an overall accurate object recognition effect.
2. The plurality of incremental branches in this application can independently form a plurality of processing branches, and can independently perform data processing when performing a target data processing procedure. Therefore, under a small overall quantity of incremental model parameters, a data analysis process during the data processing can still be enriched, thereby improving data processing accuracy.
3. The plurality of processing branches that are independent of each other may perform data processing and model parameter adjustment in parallel. Therefore, even though the plurality of processing branches are added, data processing efficiency and parameter adjustment efficiency of the model are not significantly affected, thereby ensuring data processing efficiency and model training efficiency of the model.
4. In this application, during model parameter adjustment, only the incremental model parameter is adjusted, and the model parameter corresponding to the first model remains unchanged. Therefore, while model knowledge of the first model is reserved, new model knowledge can be learned by using the incremental model parameter, thereby enriching a model knowledge amount, and further improving data processing accuracy.
5. Because an overall quantity of incremental model parameters is less than the quantity of model parameters in the main branch, and the quantity of the incremental model parameters is further reduced by simulating, in a parameter splitting manner, a large incremental model parameter by using a plurality of small incremental model parameters, a parameter adjustment amount needed in such a parameter adjustment manner is small, and model training efficiency is high.
6. In this application, downscaling a feature size of data in an incremental branch can further reduce a data processing amount needed for each incremental branch, and lower adjustment difficulty during parameter adjustment. In addition, overall data processing accuracy is ensured by using the plurality of incremental branches, thereby further improving model training efficiency.

It should be noted that some incremental learning assumes that, in each new training stage, only newly added samples are available, or at most a small portion of old samples together with the new ones. Because of this limited access to past data, most earlier incremental‑learning methods focus on addressing catastrophic forgetting—how to integrate new knowledge from new data while retaining previously learned knowledge (plasticity), while at the same time preventing new inputs from significantly interfering with existing knowledge (stability). However, the disclosed embodiments concern practical product applications, where all historical data and new data remain fully accessible. Under this condition, catastrophic forgetting is not an issue. Instead, the focus of incremental training becomes the time cost associated with the continuously growing volume of data, namely how to balance training time and training accuracy.

In a typical industrial defect-detection scenario, when the factory discovers that some defective samples were not detected, the model needs to be updated quickly. Traditional full fine-tuning or retraining requires an unacceptably long training time (usually 22 hours or more in real settings). From the moment a missed defect is found to completing model iteration, testing, and releasing an updated version, the entire process can take several days. Discovering a problem but being unable to resolve it immediately is unacceptable in manufacturing environments.

In the disclosed embodiments, by efficiently fine-tuning a backbone network (e.g., main branch) and the classification/regression heads of a two-stage object detection model, rapid model iteration can be achieved on top of a pretrained model (e.g., first model). This enables the updated model (e.g., the third model) to recognize newly added target samples with performance not lower than a model obtained through full fine-tuning or retraining, while also reducing the time required to train a new model (cutting the time by more than 50%) and improving deployment efficiency. In some embodiments, a scale‑adjusted low‑rank adaptation technique is used to perform efficient parameter fine‑tuning, reducing the overall number of parameters and lowering the time required for forward propagation and gradient descent. In addition, multiple modules can be used in parallel to further improve object‑detection accuracy without reducing training speed or inference speed. Rapid model iteration can be achieved on top of an existing pretrained model so that the current model can recognize samples of newly added classes, with recognition accuracy not lower than that of a model obtained through full fine‑tuning or retraining.

In one exemplary embodiment, the hardware for executing the disclosed method includes servers equipped with Intel Xeon 8255C CPUs and NVIDIA Tesla V100 GPUs. The software environment for running the algorithms includes Python 3.8.5, opencv-python version 4.5.1.48, numpy version 1.24.4, scikit-learn version 0.23.0, PyTorch version 1.9.1+cu102, and mmcv-full version 1.6.0.

Based on the model training method provided in the foregoing embodiments, this application further provides a model training apparatus. Refer to FIG. 11. FIG. 11 is a block diagram of a structure of a model training apparatus according to this application. The apparatus 1100 includes an obtaining unit 1101, a forming unit 1102, a determining unit 1103, and an adjusting unit 1104.

The obtaining unit 1101 is configured to obtain a first model and sample data, the first model being trained based on initial sample data, and the sample data being different from the initial sample data.

The forming unit 1102 is configured to form a second model by adding a plurality of incremental branches to the first model, the plurality of incremental branches and a main branch in the first model being all configured to perform a same type of processing operation on same data, and an overall quantity of model parameters in the plurality of incremental branches being less than a quantity of model parameters in the main branch.

The determining unit 1103 is configured to obtain, by using the second model, a pending processing result based on the sample data, the pending processing result being determined by combining processing results respectively corresponding to the plurality of incremental branches and the main branch.

The adjusting unit 1104 is configured to adjust the model parameters in the plurality of incremental branches based on a difference between the pending processing result and an annotation of the sample data, to obtain a third model.

In one embodiment, a target incremental branch is any one of the plurality of incremental branches, the target incremental branch includes a first sub-branch and a second sub-branch, an incremental model parameter in the target incremental branch includes a first parameter in the first sub-branch and a second parameter in the second sub-branch, and the determining unit 1103 is specifically configured to:

determine input data of a plurality of processing branches based on the sample data, the plurality of processing branches including the main branch and the plurality of incremental branches;

determine, by using the plurality of processing branches and based on the input data, processing results respectively corresponding to the plurality of processing branches, the target incremental branch being configured for determining first intermediate data based on the input data and the first parameter, and determining a processing result corresponding to the target incremental branch based on the first intermediate data and the second parameter, the processing results respectively corresponding to the plurality of processing branches having a same data dimension; and

determine the pending processing result by combining the processing results respectively corresponding to the plurality of processing branches.

In one embodiment, the input data is n-dimensional feature data, the processing results respectively corresponding to the plurality of processing branches all are m-dimensional feature data, the first intermediate data is r-dimensional feature data, r is less than n and m, the first sub-branch is configured to perform dimensionality reduction processing on the input data, to determine the first intermediate data, and the second sub-branch is configured to perform dimensionality expansion processing on the first intermediate data, to determine the processing result corresponding to the target incremental branch.

In one embodiment, the adjusting unit 1104 is specifically configured to:

adjust the second parameter based on the difference between the pending processing result and the annotation, and adjust the first intermediate data based on the difference between the pending processing result and the annotation, to obtain second intermediate data; and

adjust the first parameter based on a difference between the second intermediate data and the first intermediate data.

In one embodiment, the main branch is specifically configured for:

performing feature extraction on the input data, to generate a processing result corresponding to the main branch, the processing result corresponding to the main branch being feature data having a first feature size.

The target incremental branch is specifically configured for:

performing, by using the first sub-branch, feature extraction on the input data based on the first parameter, to generate the first intermediate data, the first intermediate data being feature data having a second feature size, a calculation amount needed for the feature extraction being positively correlated with the second feature size, and the second feature size being less than the first feature size; and

performing, by using the second sub-branch, data processing on the first intermediate data based on the second parameter, to determine the processing result corresponding to the target incremental branch, the data processing including size upscaling processing for upscaling a feature size, and the processing result is feature data having the first feature size.

In one embodiment, performing data processing on the first intermediate data based on the second parameter, to determine the processing result corresponding to the target incremental branch includes:

performing size upscaling processing on the first intermediate data to generate third intermediate data, the third intermediate data being feature data having the first feature size; and

determining the processing result corresponding to the target incremental branch based on the third intermediate data and the second parameter.

In one embodiment, performing feature extraction on the input data, to generate the processing result corresponding to the main branch includes:

performing feature extraction on the input data through p times of convolution processing, to generate the processing result corresponding to the main branch.

Performing feature extraction on the input data based on the first parameter, to generate the first intermediate data includes:

performing, though q times of convolution processing, feature extraction on the input data based on the first parameter, to generate the first intermediate data, q being less than p.

The size upscaling processing includes bilinear interpolation upsampling processing.

In one embodiment, performing data processing on the first intermediate data based on the second parameter, to determine the processing result corresponding to the target incremental branch includes:

determining fourth intermediate data based on the first intermediate data and the second parameter, the fourth intermediate data being feature data having the second feature size; and

performing size upscaling processing on the fourth intermediate data to generate the processing result corresponding to the target incremental branch.

In one embodiment, the adjusting unit 1104 is specifically configured to:

perform a plurality of rounds of parameter adjustment on the model parameters in the plurality of incremental branches based on the difference between the pending processing result and the annotation, the plurality of rounds of parameter adjustment each having a corresponding learning rate, the learning rate decreasing as a quantity of rounds of parameter adjustment increases in the plurality of rounds of parameter adjustment, a target round of parameter adjustment being any one of the plurality of rounds of parameter adjustment, a learning rate corresponding to the target round of parameter adjustment being configured for controlling adjustment magnitude of the model parameters in the plurality of incremental branches, and the learning rate corresponding to the target round of parameter adjustment being positively correlated with the adjustment magnitude.

In one embodiment, the adjusting unit 1104 is specifically configured to:

adjust the model parameters in the plurality of incremental branches in parallel based on the difference between the pending processing result and the annotation, to obtain the third model.

In one embodiment, the sample data and the initial sample data are both images.

The first model is configured for recognizing a category of a first object in the initial sample data.

The third model is configured for recognizing the category of the first object in the initial sample data and a category of a second object in the sample data.

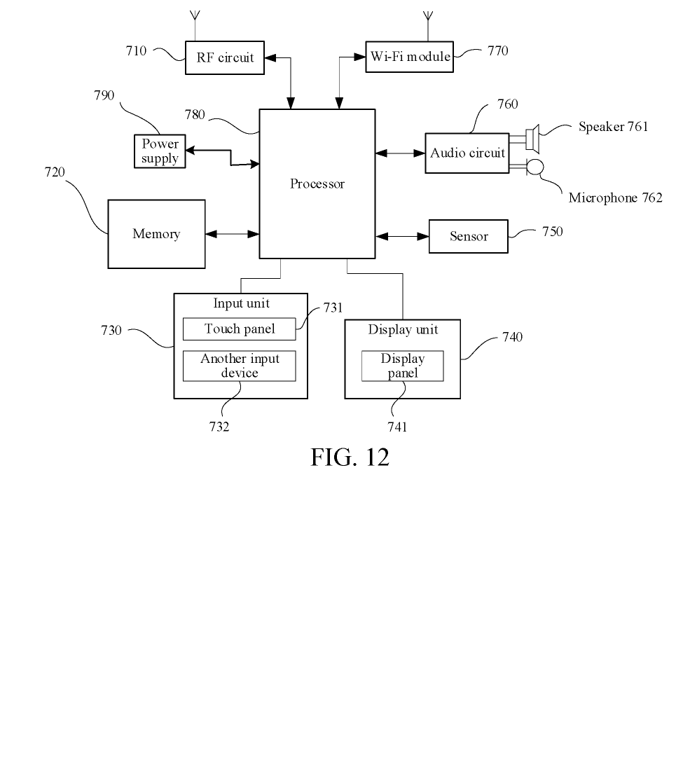

An embodiment of this application further provides a computer device. Refer to FIG. 12. The computer device may be a terminal device. An example in which the terminal device is a mobile phone is used.

FIG. 12 is a block diagram of a structure of a part of a mobile phone related to a terminal device according to an embodiment of this application. Refer to FIG. 12. The mobile phone includes a radio frequency (RF) circuit 710, a memory 720, an input unit 730, a display unit 740, a sensor 750, an audio circuit 760, a wireless fidelity (Wi-Fi) module 770, a processor 780, a power supply 790, and another component. A person skilled in the art may understand that the structure of the mobile phone shown in FIG. 12 does not constitute a limitation on the mobile phone, and the mobile phone may include more or fewer components than those shown in the figure, or some components may be combined, or a different component deployment may be used.

The following specifically describes the components of the mobile phone with reference to FIG. 12.

The RF circuit 710 may be configured to receive and transmit signals in an information receiving and transmitting process or a call process. Specifically, the RF circuit 710 receives downlink information from a base station, then delivers the downlink information to the processor 780 for processing, and transmits uplink data from the mobile phone to the base station. Generally, the RF circuit 710 includes, but is not limited to, an antenna, at least one amplifier, a transceiver, a coupler, a low noise amplifier (LNA), a duplexer, and the like. In addition, the RF circuit 710 may also communicate with a network and another device through wireless communication. The wireless communication may use any communication standard or protocol, which includes but is not limited to global system for mobile communications (GSM), general packet radio service (GPRS), code division multiple access (CDMA), wideband code division multiple access (WCDMA), long term evolution (LTE), email, short message service (SMS), and the like.

The memory 720 may be configured to store a software program and a module. The processor 780 runs the software program and the module stored in the memory 720, to execute various functional applications of the mobile phone and perform data processing. The memory 720 may mainly include a program storage area and a data storage area. The program storage area may store an operating system, an application program required by at least one function (for example, a sound playback function or an image playback function), and the like. The data storage area may store data (such as audio data or a phone book) created based on use of the mobile phone, and the like. In addition, the memory 720 may include a high-speed random access memory, and may further include a non-volatile memory, such as at least one disk storage device, a flash memory device, or another volatile solid-state storage device.

The input unit 730 may be configured to receive inputted digit or character information, and generate a keyboard signal input related to user settings and function control of the mobile phone. Specifically, the input unit 730 may include a touch panel 731 and another input device 732. The touch panel 731, also referred to as a touchscreen, may collect a touch operation of a user on or near the touch panel (such as an operation of the user on or near the touch panel 731 by using any suitable object or accessory such as a finger or a stylus), and drive a corresponding connection apparatus according to a preset program. In some embodiments, the touch panel 731 may include two parts: a touch detection apparatus and a touch controller. The touch detection apparatus detects a touch location of the user, detects a signal generated by the touch operation, and transfers the signal to the touch controller. The touch controller receives touch information from the touch detection apparatus, converts the touch information into touch point coordinates, and transmits the touch point coordinates to the processor 780. Moreover, the touch controller can receive and execute a command sent from the processor 780. In addition, the touch panel 731 may be implemented by using various types of control panels, such as a resistive control panel, a capacitive control panel, an infrared control panel, and a surface acoustic wave control panel. In addition to the touch panel 731, the input unit 730 may further include the another input device 732. Specifically, the another input device 732 may include, but is not limited to, one or more of a physical keyboard, a functional key (such as a volume control key or a switch key), a track ball, a mouse, and a joystick.

The display unit 740 may be configured to display information inputted by the user or information provided for the user, and various menus of the mobile phone. The display unit 740 may include a display panel 741. In some embodiments, the display panel 741 may be configured by using a liquid crystal display (LCD), an organic light-emitting diode (OLED), or the like. Further, the touch panel 731 may cover the display panel 741. After detecting a touch operation on or near the touch panel 731, the touch panel 731 transfers the touch operation to the processor 780, to determine a type of a touch event. Then, the processor 780 provides a corresponding visual output on the display panel 741 based on the type of the touch event. Although in FIG. 12, the touch panel 731 and the display panel 741 are used as two separate components to implement input and output functions of the mobile phone, in some embodiments, the touch panel 731 and the display panel 741 may be integrated to implement the input and output functions of the mobile phone.

The mobile phone may further include at least one sensor 750 such as an optical sensor, a motion sensor, and another sensor. Specifically, the optical sensor may include an ambient light sensor and a proximity sensor, where the ambient light sensor may adjust luminance of the display panel 741 based on luminance of ambient light, and the proximity sensor may disable the display panel 741 and/or backlight when the mobile phone is moved to the ear. As one type of motion sensor, an acceleration sensor can measure magnitude of accelerations in various directions (generally on three axes), may detect magnitude and a direction of the gravity when static, and may be configured for application of mobile phone attitude recognition (for example, switching between landscape orientation and portrait orientation, a related game, or magnetometer attitude calibration), a function related to vibration recognition (such as a pedometer and a knock), and the like. Other sensors, such as a gyroscope, a barometer, a hygrometer, a thermometer, and an infrared sensor, which may be configured in the mobile phone, are not described in detail herein.

The audio circuit 760, a speaker 761, and a microphone 762 may provide audio interfaces between the user and the mobile phone. The audio circuit 760 may transmit, to the speaker 761, an electric signal converted from received audio data. The speaker 761 converts the electric signal into a sound signal for output. In addition, the microphone 762 converts a collected sound signal into an electric signal. The audio circuit 760 receives the electric signal, converts the electric signal into audio data, and then outputs the audio data to the processor 780 for processing. Then, the processor 780 transmits processed audio data to, for example, another mobile phone through the RF circuit 710, or outputs the audio data to the memory 720 for further processing.

Wi-Fi is a short-range wireless transmission technology. The mobile phone may help, by using a Wi-Fi module 770, a user to receive and transmit an email, browse a web page, access stream media, and the like, to allow wireless broadband Internet access of the user. Although FIG. 12 shows the Wi-Fi module 770, the Wi-Fi module 770 is not a necessary component of the mobile phone, and may be omitted based on needs provided that the scope of the essence of the present disclosure is not changed.

The processor 780 is a control center of the mobile phone, and is connected to various parts of the entire mobile phone by using various interfaces and lines. By running or executing the software program and/or the module stored in the memory 720, and invoking data stored in the memory 720, the processor executes various functions of the mobile phone and performs data processing, thereby monitoring the entire mobile phone. In some embodiments, the processor 780 may include one or more processing units. Preferably, the processor 780 may integrate an application processor and a modem processor, where the application processor mainly handles an operating system, a user interface, application programs, and the like, and the modem processor mainly handles wireless communication. The modem processor may alternatively not be integrated into the processor 780.

The mobile phone further includes the power supply 790 (such as a battery) for supplying power to the components. Preferably, the power supply may be logically connected to the processor 780 via a power supply management system, thereby implementing functions such as charging, discharging, and power consumption management based on the power supply management system.

Although not shown in the figure, the mobile phone may further include a camera, a Bluetooth module, and the like, which are not described in detail herein.

In this embodiment, the processor 780 included in the terminal device is further configured to perform any implementation in the model training method provided in the embodiments of this application.

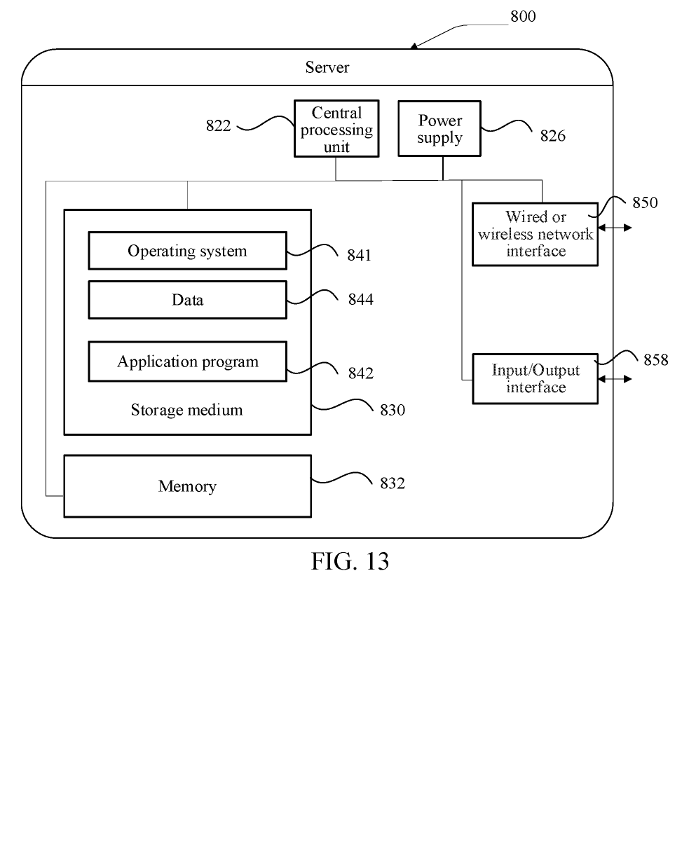

An embodiment of this application further provides a server. Refer to FIG. 13. FIG. 13 is a diagram of a structure of a server 800 according to an embodiment of this application. The server 800 may vary greatly due to different configurations or performance, and may include one or more central processing units (CPUs) 822 (for example, one or more processors), a memory 832, and one or more storage media 830 (for example, one or more mass storage devices) that store application programs 842 or data 844. The memory 832 and the storage medium 830 may be transient or persistent storages. A program stored in the storage medium 830 may include one or more modules (not shown in the figure), and each module may include a series of instruction operations on the server. Further, the central processing unit 822 may be configured to communicate with the storage medium 830, and perform, on the server 800, the series of instruction operations in the storage medium 830.

The server 800 may further include one or more power supplies 826, one or more wired or wireless network interfaces 850, one or more input/output interfaces 858, and/or one or more operating systems 841, for example, Windows ServerTM, Mac OS XTM, UnixTM, LinuxTM, and FreeBSDTM.

Operations performed by the server in the foregoing embodiments may be based on the structure of the server shown in FIG. 13.

An embodiment of this application further provides a computer-readable storage medium, configured to store a computer program, the computer program being configured to perform any implementation in the model training method according to the foregoing embodiments.

An embodiment of this application further provides a computer program product including a computer program. When the computer program product is run on a computer device, the computer device is enabled to perform the model training method according to any one of the foregoing embodiments.

In the specific implementation of this application, relevant data such as user information is involved. When the foregoing embodiments of this application are applied to a specific product or technology, user permission or consent is required, and collection, use, and processing of the relevant data need to comply with relevant laws, regulations, and standards of relevant countries and regions.

A person of ordinary skill in the art may understand that all or some of the operations of the method embodiments may be implemented by relevant hardware instructed by using a program. The program may be stored in a computer-readable storage medium. When the program is executed, the operations of the method embodiments are performed. The storage medium may be at least one of the following media: any medium that can store program code, such as a read-only memory (ROM), a RAM, a magnetic disk, or an optical disc.

The embodiments in this specification are all described in a progressive manner, for same or similar parts in the embodiments, mutual reference may be made to these embodiments, and each embodiment focuses on a difference from other embodiments. Especially, device and system embodiments are basically similar to the method embodiments, and therefore is described briefly. For related parts, refer to partial descriptions in the method embodiments. The described device and system embodiments are merely exemplary. The units described as separate components may or may not be physically separated, and components displayed as units may or may not be physical units, may be located in one location, or may be distributed on a plurality of network units. Some or all of the modules may be selected based on actual needs to achieve the objectives of the solutions of the embodiments. A person of ordinary skill in the art may understand and implement the embodiments without creative efforts.

The foregoing descriptions are merely a specific implementation of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A model training method, performed by a computer device, and comprising: obtaining a first model and sample data, the first model being trained based on initial sample data, and the sample data being different from the initial sample data; forming a second model by adding a plurality of incremental branches to the first model, the plurality of incremental branches and a main branch in the first model being configured to perform a same type of processing operation on same data, and an overall quantity of model parameters in the plurality of incremental branches being less than a quantity of model parameters in the main branch; determining, by using the second model based on the sample data, a pending processing result by combining processing results respectively corresponding to the plurality of incremental branches and the main branch; and adjusting the model parameters in the plurality of incremental branches based on a difference between the pending processing result and an annotation of the sample data, to obtain a third model.

2. The method according to claim 1, wherein a target incremental branch is one of the plurality of incremental branches, the target incremental branch comprises a first sub-branch and a second sub-branch, model parameters in the target incremental branch comprise a first parameter in the first sub-branch and a second parameter in the second sub-branch, and the obtaining, by using the second model, a pending processing result based on the sample data comprises: determining input data of a plurality of processing branches based on the sample data, the plurality of processing branches comprising the main branch and the plurality of incremental branches; determining, by using the plurality of processing branches and based on the input data, processing results respectively corresponding to the plurality of processing branches, comprising: determining, by using the target incremental branch, first intermediate data based on the input data and the first parameter, and determining, by using the target incremental branch, a processing result corresponding to the target incremental branch based on the first intermediate data and the second parameter, wherein the processing results respectively corresponding to the plurality of processing branches have a same data dimension; and combining the processing results respectively corresponding to the plurality of processing branches, to determine the pending processing result.

3. The method according to claim 2, wherein the input data is n-dimensional feature data, the processing results respectively corresponding to the plurality of processing branches are m-dimensional feature data, the first intermediate data is r-dimensional feature data, r is less than n and m, and determining the processing result corresponding to the target incremental branch comprises:
performing, by using the first sub-branch, dimensionality reduction processing on the input data, to determine the first intermediate data; and
performing, by using the second sub-branch, dimensionality expansion processing on the first intermediate data, to determine the processing result corresponding to the target incremental branch.

4. The method according to claim 2, wherein the adjusting the model parameters in the plurality of incremental branches based on a difference between the pending processing result and an annotation of the sample data, to obtain a third model comprises: adjusting the second parameter based on the difference between the pending processing result and the annotation, and adjusting the first intermediate data based on the difference between the pending processing result and the annotation, to obtain second intermediate data; and adjusting the first parameter based on a difference between the second intermediate data and the first intermediate data.

5. The method according to claim 2, wherein determining, by using the plurality of processing branches and based on the input data, processing results respectively corresponding to the plurality of processing branches comprises: performing feature extraction on the input data, to generate a processing result corresponding to the main branch, the processing result corresponding to the main branch being feature data having a first feature size; and performing, by using the first sub-branch, feature extraction on the input data based on the first parameter, to generate the first intermediate data, the first intermediate data being feature data having a second feature size and the second feature size being less than the first feature size; and performing, by using the second sub-branch, data processing on the first intermediate data based on the second parameter, to determine the processing result corresponding to the target incremental branch, the data processing comprising size upscaling processing for upscaling a feature size, and the processing result is feature data having the first feature size.

6. The method according to claim 5, wherein the performing data processing on the first intermediate data based on the second parameter, to determine the processing result corresponding to the target incremental branch comprises: performing size upscaling processing on the first intermediate data to generate third intermediate data, the third intermediate data being feature data having the first feature size; and determining the processing result corresponding to the target incremental branch based on the third intermediate data and the second parameter.

7. The method according to claim 5, wherein the performing feature extraction on the input data, to generate a processing result corresponding to the main branch comprises: performing feature extraction on the input data through p times of convolution processing, to generate the processing result corresponding to the main branch; and the performing feature extraction on the input data based on the first parameter, to generate the first intermediate data comprises: performing, though q times of convolution processing, feature extraction on the input data based on the first parameter, to generate the first intermediate data, q being less than p, wherein the size upscaling processing comprises bilinear interpolation upsampling processing.

8. The method according to claim 5, wherein the performing data processing on the first intermediate data based on the second parameter, to determine the processing result corresponding to the target incremental branch comprises: determining fourth intermediate data based on the first intermediate data and the second parameter, the fourth intermediate data being feature data having the second feature size; and performing size upscaling processing on the fourth intermediate data to generate the processing result corresponding to the target incremental branch.

9. The method according to claim 1, wherein the adjusting the model parameters in the plurality of incremental branches based on a difference between the pending processing result and an annotation of the sample data, to obtain a third model comprises: performing a plurality of rounds of parameter adjustment on the model parameters in the plurality of incremental branches based on the difference between the pending processing result and the annotation, the plurality of rounds of parameter adjustment each having a corresponding learning rate, the learning rate decreasing as a quantity of rounds of parameter adjustment increases in the plurality of rounds of parameter adjustment, a target round of parameter adjustment being one of the plurality of rounds of parameter adjustment, a learning rate corresponding to the target round of parameter adjustment being configured for controlling adjustment magnitude of the model parameters in the plurality of incremental branches, and the learning rate corresponding to the target round of parameter adjustment being positively correlated with the adjustment magnitude.

10. The method according to claim 1, wherein the adjusting the model parameters in the plurality of incremental branches based on a difference between the pending processing result and an annotation of the sample data, to obtain a third model comprises: adjusting the model parameters in the plurality of incremental branches in parallel based on the difference between the pending processing result and the annotation, to obtain the third model.

11. The method according to claim 1, wherein the sample data and the initial sample data are both images; the first model is configured to recognize a category of a first object in the initial sample data; and the third model is configured to recognize the category of the first object in the initial sample data and a category of a second object in the sample data.

12. A computer device, the computer device comprising a processor and a memory, wherein the memory is configured to store a computer program and transmit the computer program to the processor; and the processor is configured to, according to an instruction in the computer program, perform: obtaining a first model and sample data, the first model being trained based on initial sample data, and the sample data being different from the initial sample data; forming a second model by adding a plurality of incremental branches to the first model, the plurality of incremental branches and a main branch in the first model being configured to perform a same type of processing operation on same data, and an overall quantity of model parameters in the plurality of incremental branches being less than a quantity of model parameters in the main branch; determining, by using the second model based on the sample data, a pending processing result by combining processing results respectively corresponding to the plurality of incremental branches and the main branch; and adjusting the model parameters in the plurality of incremental branches based on a difference between the pending processing result and an annotation of the sample data, to obtain a third model.

13. The computer device according to claim 12, wherein a target incremental branch is one of the plurality of incremental branches, the target incremental branch comprises a first sub-branch and a second sub-branch, model parameters in the target incremental branch comprise a first parameter in the first sub-branch and a second parameter in the second sub-branch, and the obtaining, by using the second model, a pending processing result based on the sample data comprises: determining input data of a plurality of processing branches based on the sample data, the plurality of processing branches comprising the main branch and the plurality of incremental branches; determining, by using the plurality of processing branches and based on the input data, processing results respectively corresponding to the plurality of processing branches, comprising: determining, by using the target incremental branch, first intermediate data based on the input data and the first parameter, and determining, by using the target incremental branch, a processing result corresponding to the target incremental branch based on the first intermediate data and the second parameter, wherein the processing results respectively corresponding to the plurality of processing branches have a same data dimension; and combining the processing results respectively corresponding to the plurality of processing branches, to determine the pending processing result.

14. The computer device according to claim 13, wherein determining, by using the plurality of processing branches and based on the input data, processing results respectively corresponding to the plurality of processing branches comprises: performing feature extraction on the input data, to generate a processing result corresponding to the main branch, the processing result corresponding to the main branch being feature data having a first feature size; and performing, by using the first sub-branch, feature extraction on the input data based on the first parameter, to generate the first intermediate data, the first intermediate data being feature data having a second feature size and the second feature size being less than the first feature size; and performing, by using the second sub-branch, data processing on the first intermediate data based on the second parameter, to determine the processing result corresponding to the target incremental branch, the data processing comprising size upscaling processing for upscaling a feature size, and the processing result is feature data having the first feature size.

15. The computer device according to claim 14, wherein the performing data processing on the first intermediate data based on the second parameter, to determine the processing result corresponding to the target incremental branch comprises: performing size upscaling processing on the first intermediate data to generate third intermediate data, the third intermediate data being feature data having the first feature size; and determining the processing result corresponding to the target incremental branch based on the third intermediate data and the second parameter.

16. The computer device according to claim 14, wherein the performing feature extraction on the input data, to generate a processing result corresponding to the main branch comprises: performing feature extraction on the input data through p times of convolution processing, to generate the processing result corresponding to the main branch; and the performing feature extraction on the input data based on the first parameter, to generate the first intermediate data comprises: performing, though q times of convolution processing, feature extraction on the input data based on the first parameter, to generate the first intermediate data, q being less than p, wherein the size upscaling processing comprises bilinear interpolation upsampling processing.

17. The computer device according to claim 14, wherein the performing data processing on the first intermediate data based on the second parameter, to determine the processing result corresponding to the target incremental branch comprises: determining fourth intermediate data based on the first intermediate data and the second parameter, the fourth intermediate data being feature data having the second feature size; and performing size upscaling processing on the fourth intermediate data to generate the processing result corresponding to the target incremental branch.

18. The computer device according to claim 12, wherein the adjusting the model parameters in the plurality of incremental branches based on a difference between the pending processing result and an annotation of the sample data, to obtain a third model comprises: adjusting the model parameters in the plurality of incremental branches in parallel based on the difference between the pending processing result and the annotation, to obtain the third model.

19. The computer device according to claim 12, wherein the sample data and the initial sample data are both images; the first model is configured to recognize a category of a first object in the initial sample data; and the third model is configured to recognize the category of the first object in the initial sample data and a category of a second object in the sample data.

20. A non-transitory computer-readable storage medium, the computer-readable storage medium being configured to store a computer program, and the computer program, when being executed by at least one processor, causing the at least one processor to perform: obtaining a first model and sample data, the first model being trained based on initial sample data, and the sample data being different from the initial sample data; forming a second model by adding a plurality of incremental branches to the first model, the plurality of incremental branches and a main branch in the first model being configured to perform a same type of processing operation on same data, and an overall quantity of model parameters in the plurality of incremental branches being less than a quantity of model parameters in the main branch; determining, by using the second model based on the sample data, a pending processing result by combining processing results respectively corresponding to the plurality of incremental branches and the main branch; and adjusting the model parameters in the plurality of incremental branches based on a difference between the pending processing result and an annotation of the sample data, to obtain a third model.
